(19) United States
(12) Patent Application Publication
(10) Pub. No.: US 2018/0019778 A1
(43) Pub. Date: Jan. 18, 2018

(54) MOBILE PHONE CASE

(71) Applicant: Zhengmin Benjamin Pan, L.A., CA (US)

(72) Inventor: Zhengmin Benjamin Pan, L.A., CA (US)

(73) Assignee: AAC Technologies Pte. Ltd., Singapore city (SG)

(21) Appl. No.: 15/416,895

(22) Filed: Jan. 26, 2017

(30) Foreign Application Priority Data
Jul. 18, 2016 (CN) 201620754267.4

(51) Int. Cl. H04M 1/02

(52) U.S. Cl. CPC H04B 1/3888; H04M 1/0266

(57) ABSTRACT

A mobile phone, includes a main screen; edge screens each forming an angle with the main screen; a screen cover having a main cover body for protecting the main screen of the mobile phone and edge covers formed by bending and extending from edges of the main cover body for protecting the edge screen of the mobile phone. The main cover body is shaped to match the main screen of the mobile phone and the edge covers are shaped to match the edge screens of the mobile phone.

### FIELD OF THE INVENTION

The present invention relates to the technical field of mobile phone accessories, and more specifically, to a mobile phone case.

### DESCRIPTION OF RELATED ART

With the development of the communication industry, keypad mobile phones have been developed into touch-screen mobile phones. The touch screen has both the function of information display and control signal input, and it becomes larger and larger, which facilitates the use of mobile phones. However, compared to the keypad mobile phone, the touch-screen mobile phone is fragile. To protect the mobile phone and prolong the life time, users generally use a case to protect the screen and improve the drop resistance of the touch-screen mobile phone.

In related technology, the screen of the touch-screen mobile phones is a main screen and it will be covered with a mobile phone case when the mobile phone is not in use to prevent the main screen from being broken by external forces. A curved edge screen mobile phone emerges with the users' higher requirements for mobile phones' performance and wins the growing popularity of the users. The edge of the curved edge screen mobile phone is slightly curved and a small portion of the screen is exposed from the boundary, so more details can be displayed and the design is more user-friendly. However, there is no corresponding mobile phone case for such curved edge screen mobile phones in the related technology.

Therefore, it is necessary to provide an improved mobile phone case to overcome above disadvantage.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an illustrative and isometric view of a mobile phone ready to be cooperated with a mobile phone case in accordance with an exemplary embodiment of the present disclosure.

FIG. 2 is an illustrative and isometric view of the mobile phone case.

FIG. 3 is an assembled view of the mobile phone case and the mobile phone.

### DETAILED DESCRIPTION OF THE EXEMPLARY EMBODIMENT

The present invention will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiments described hereby is only to explain this disclosure, not intended to limit this disclosure.

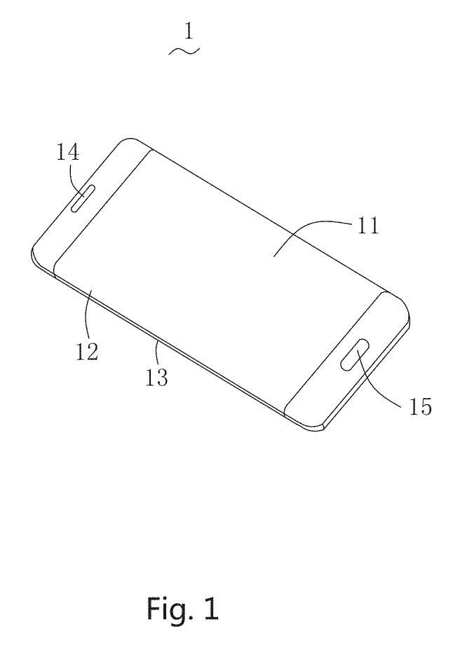

With reference to FIG. 1, a mobile phone 1 comprises a main screen 11, edge screens 12, a back cover 13, a loudspeaker hole 14, and a main keypad 15.

The edge screens 12 are located at the left and right side of the main screen 11 and formed by bending and extending the two edges of the main screen 11. The loudspeaker hole 14 and the main keypad 15 are arranged at the same side as the main screen 11 and located at the upper end and the lower end of the main screen 11.

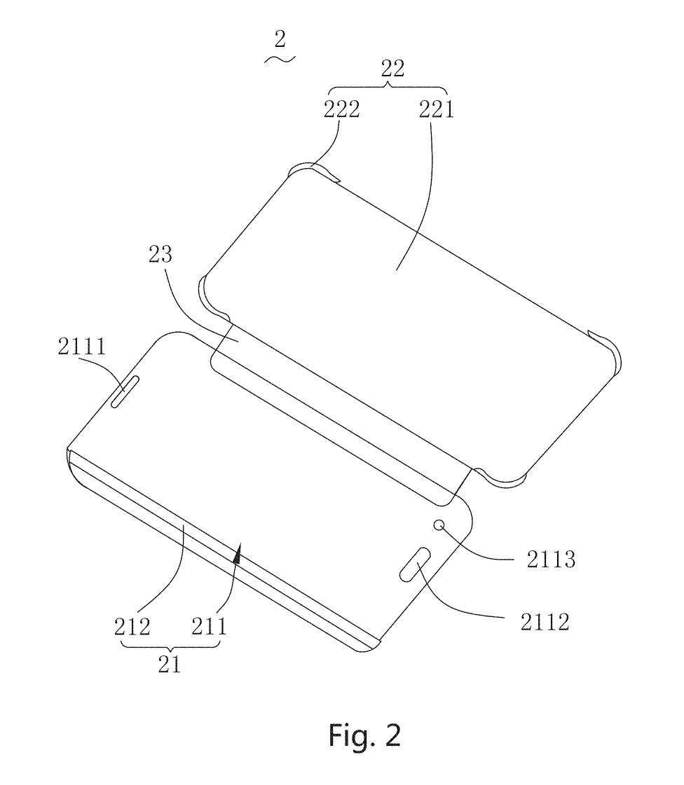

With reference to FIG. 2, a mobile phone case comprises a screen cover 21, a back cover body 22 and a connecting part 23, wherein the connecting part 23 is connected to the screen cover 21 and the back cover body 22 at its two sides, and the screen cover 21 is made of transparent or translucent silica gel.

The screen cover 21 comprises a main cover body 211 and edge covers 212.

The main cover body 211 is intended for protecting the main screen 11 and shaped to match the main screen 11. The cover body 211 covers the main screen 11 when it is in use. The main cover body 211 comprises a through-hole 2111, a main-keypad accepting portion 2112 and an attaching device 2113.

The through-hole 2111 and the main-keypad accepting portion 2112 are arranged at the opposite ends of the main cover body 211, wherein the through-hole is located at the upper end of the main cover body 211 and shaped to match the loudspeaker 14 to facilitate answering the mobile phone 1 assembled with the mobile phone case 2; the main-keypad accepting portion 2112 is located inside the main cover body 211 and at the lower end of the main cover body 211 and shaped to match the main keypad 15. The main keypad 15 fits into the main-keypad accepting portion 2112 when the accepting portion is in use.

The attaching device 2113 is arranged inside the main cover body 211 and intended for attaching the screen cover 21 to the main screen 11. The attaching device 2113 is a magnetic element.

There are two edge covers 212 which are arranged at the left and right side edges of the main cover body 211 and intended for protecting the edge screens 12. The two edge covers 212 are formed by bending and extending the two opposite edges of the main cover body 211 respectively. The edge covers 212 are shaped to match the edge screens 12, and they cover the edge screens 12 when in use.

The back cover body 22 comprises a body 221 and a snap-fitting portion 222 formed by bending and extending the four corners of the body 221, wherein the snap-fitting potion 222 is a corner wrapping structure. The mobile phone 1 will not move in the case once the mobile phone 1 is placed into the mobile phone case 2.

The connecting part 23 is connected to the screen cover 21 and the back cover body 22 at its two sides respectively in such a way that the screen cover 21 can rotate around the connecting part 23. The connecting part 23 is connected with one of the edge covers 212 of the screen cover 21.

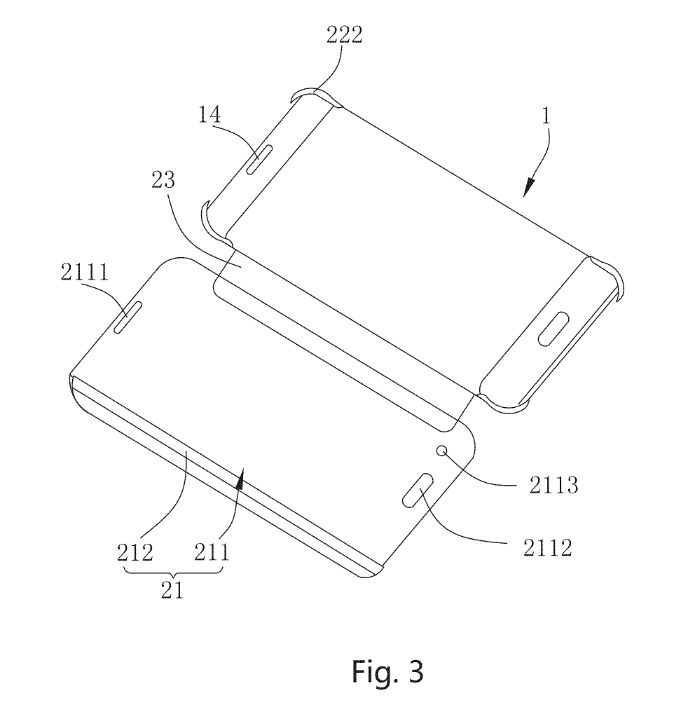

With reference to FIG. 3, the back cover 13 attaches to the internal surface of the body 221 of the back cover body 22, the snap-fitting portion 222 is locked to the four corners of the mobile phone 1. When the screen cover 21 is flapped to rotate around the connecting part 23 and cover the screen of the mobile phone, the main cover body 211 covers the main screen 11 of the mobile phone and the edge covers 212 cover the edge screens 12. As a practical embodiment, the back cover body 22 serves as the back cover 13 of the mobile phone.

Compared to related technology, the beneficial effects of the mobile phone according to the present utility model include: the screen cover 21 comprises a main cover body 211 and edge covers 212 formed by bending and extending the two edges of the main cover body 211, wherein the main cover body 211 is shaped to match the main screen 11 of the mobile phone and the edge covers 212 are shaped to match the edge screens 12 of the mobile phone so that when the mobile phone case 2 is in use, the main cover body 211 covers the main screen 11 of the mobile phone and the edge covers 212 cover the edge screens 12 of the mobile phone, thus the main screen 11 and the edge screens 12 are not easily broken by external forces, so the life time of the curved edge screen mobile phone is prolonged.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A mobile phone case, comprising:
a screen cover including a main cover body; and
edge covers formed by bending and extending from edges of the main cover body.

2. The mobile phone case as described in claim 1, wherein the screen cover is made of transparent or translucent silica gel.

3. The mobile phone case as described in claim 1, wherein two edge covers are arranged at two opposite side edges of the main cover body respectively.

4. The mobile phone case as described in claim 1, wherein the main cover body comprises a through-hole located at its end.

5. The mobile phone case as described in claim 1, wherein the main cover body comprises a main-keypad accepting portion.

6. The mobile phone case as described in claim 1, wherein the main cover body comprises an attaching device located inside the main cover body.

7. The mobile phone case as described in claim 6, wherein the attaching device is a magnetic element.

8. The mobile phone case as described in claim 1, wherein the mobile phone case also comprises a back cover body and a connecting part, wherein two sides of the connecting part are respectively connected to the back cover body and the screen cover, and the screen cover can rotate around the connecting part.

9. The mobile phone case as described in claim 8, wherein the back cover body comprises a body and a snap-fitting portion formed by bending and extending the four corners of the body.

10. A mobile phone, comprising:
a main screen;
edge screens each forming an angle with the main screen;
a screen cover comprising a main cover body for protecting the main screen of the mobile phone and edge covers formed by bending and extending from edges of the main cover body for protecting the edge screen of the mobile phone;
wherein the main cover body is shaped to match the main screen of the mobile phone and the edge covers are shaped to match the edge screens of the mobile phone.

11. The mobile phone as described in claim 10, wherein the screen cover is made of transparent or translucent silica gel.

12. The mobile phone as described in claim 10, wherein two edge covers which are arranged at two opposite side edges of the main cover body respectively.

13. The mobile phone as described in claim 10, wherein the main cover body comprises a through-hole located at its end and shaped to match a loudspeaker hole of the mobile phone.

14. The mobile phone as described in claim 10, wherein the main cover body comprises a main-keypad accepting portion which is shaped to match a main keypad of the mobile phone.

15. The mobile phone as described in claim 10, wherein the main cover body comprises an attaching device located inside the main cover body and intended for tightly attaching the screen cover to the main screen of the mobile phone.

16. The mobile phone as described in claim 15, wherein the attaching device is a magnetic element.

17. The mobile phone as described in claim 10, wherein the mobile phone case also comprises a back cover body intended for protecting a back of the mobile phone and a connecting part, wherein two sides of the connecting part are respectively connected to the back cover body and the screen cover, and the screen cover can rotate around the connecting part.

18. The mobile phone as described in claim 17, wherein the back cover body serves as the back cover of the mobile phone.

19. The mobile phone as described in claim 17, wherein the back cover body comprises a body and a snap-fitting portion formed by bending and extending the four corners of the body and intended for snap-fitting the mobile phone.
